(19) United States
(12) Patent Application Publication
(10) Pub. No.: US 2007/0124155 A1
(43) Pub. Date: May 31, 2007

(54) Consolidating and managing hardware maintenance services

(75) Inventors: Jeff White, Kennesaw, GA (US); Debbie Carter McCollum, Vestavia Hills, AL (US); William James Fagan, Trussville, AL (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/290,348

(22) Filed: Nov. 30, 2005

(51) Int. Cl. G06Q 99/00

(52) U.S. Cl. 705/1

(57) ABSTRACT

Methods, systems, and computer program products consolidate and manage maintenance services for hardware devices and their associated operating system. A method involves categorizing each hardware device into one of a plurality of device categories, establishing support levels where each support level defines service response criteria, and pricing services based on the support level and/or the device category to which a hardware device is assigned. The method also involves receiving a problem resolution request associated with a hardware device and generating problem case data associated with the problem resolution request and dispatching the problem case data to a single primary service provider regardless of which hardware device is associated with the request.

### TECHNICAL FIELD

The present invention generally relates to reducing costs and complexity associated with maintaining hardware devices and, more particularly, relates to methods, computer-readable mediums, and systems for consolidating and managing server maintenance services.

### BACKGROUND

Curtailing the cost and complexity associated with hardware device maintenance and problem resolution is an issue that telecommunications companies and other large corporations struggle with on a daily basis. One company alone could have thousands of mid-range servers and storage devices in regular use throughout a region. These hardware devices may originate from different original equipment manufacturers (OEMs), which can complicate matters when dealing with thousands of hardware devices. Managing all of the contracts and invoices associated with hardware break/fix maintenance on all of the hardware devices is a tremendous amount of work and is done at a significant cost.

For instance, some OEMs may take up to 90 days to cancel maintenance and/or stop billing once a cancellation request is submitted. This can cost companies millions of dollars in unnecessary maintenance cost each year. Also some OEMs are lacking in flexibility when it comes to maintenance pricing and support level options. Companies often pay a premium or sign up for confusing short-term deals that provide an apparent temporary break in pricing. In some cases, OEMs no longer provide service for older models. Managing hardware maintenance costs, service levels, contracts and billing remains a significant issue in industry as corporations continue to look for ways to reduce costs and complexity with an effective and easy to understand managed maintenance program.

Accordingly there is an unaddressed need in the industry to address the aforementioned and other deficiencies and inadequacies.

### SUMMARY

This Summary is provided to introduce a selection of concepts in simplified form that are further described below in the Detailed Description. This Summary is not intended to identify key features or essential features of the claimed subject matter, nor is the Summary intended for use as an aid in determining the scope of the claimed subject matter.

In accordance with embodiments of the present invention, the above and other problems are addressed by methods, systems, and computer program products for consolidating and managing hardware maintenance services for hardware devices. Embodiments of the present invention include a program and a financial model that will consolidate hardware maintenance services and allow one supplier or primary service provider to manage hardware break/fix maintenance for a majority of a company's hardware devices. Systems and methods according to embodiments of the present invention generate significant cost savings and provide value additions such as potential zero day notice for additions and removal of devices from the managed maintenance program and no-charge installs, moves, adds, and/or changes (IMACs). Pricing for hardware device maintenance is consolidated and managed to include “unit pricing” which places several hardware device models in a category, all with the same price point greatly simplifying the cost estimation process. In summary, systems and methods according to embodiments of the present invention address several flexibility and complexity issues along with enabling tremendous cost savings.

One embodiment is a method for consolidating and managing hardware maintenance services for hardware devices. The method involves categorizing each hardware device into one of a plurality of device categories, establishing support levels where each support level defines service response criteria, and pricing services based on the support level and/or the device category to which a hardware device is assigned. The method also involves receiving a problem resolution request associated with a hardware device, generating problem case data associated with the request, and dispatching the problem case data to a single primary service provider regardless of which hardware device is associated with the request.

Another embodiment is a computer program product comprising a computer-readable medium having control logic stored therein for causing a computer to consolidate and manage hardware maintenance services for a plurality of hardware devices. The control logic includes computer-readable program code for causing the computer to categorize each hardware device into one of multiple device categories, establish support levels where each support level defines service response criteria, and price services based on the device category to which a hardware device is assigned and/or the support level. The control logic also includes computer-readable program code for causing the computer to receive a problem resolution request associated with a hardware device, generate problem case data associated with the request, and dispatch the problem case data to a single primary service provider regardless of which hardware device is associated with the request.

Still another embodiment is a computer-implemented system for consolidating and managing hardware maintenance services for hardware devices. The system includes one or more components that are operative to categorize each hardware device into a device category, establish support levels defining service response criteria; and price services based on the device category to which a hardware device is assigned or the support level. The system also includes one or more components operative to receive a problem resolution request associated with a hardware device, and dispatch the problem resolution request to a single primary service provider for any hardware device associated with the request.

Aspects of the invention may be implemented as a business method, a computer process, a computing system, or as an article of manufacture such as a computer program product or computer-readable medium. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 is a diagram illustrating the routing of a hardware maintenance or operating system problem according to an illustrative embodiment of the invention;

FIG. 2 is a block diagram illustrating various features of a consolidated managed maintenance operating environment utilized in an illustrative embodiment of the invention;

FIG. 3 illustrates a display of support levels outlining a variety of support response criteria according to an illustrative embodiment of the invention;

FIG. 4 illustrates a display of unit pricing based on assigned categories, support level, and warranty status according to an illustrative embodiment of the invention;

FIG. 5 schematic diagram illustrating aspects of a networked operating environment utilized in an illustrative embodiment of the invention;

FIG. 6 illustrates computing system architecture for a consolidated managed maintenance server computer utilized in an illustrative embodiment of the invention; and

FIG. 7 illustrates an operational flow performed in consolidating and managing hardware maintenance services for hardware devices according to an illustrative embodiment of the invention.

### DETAILED DESCRIPTION

As described briefly above, embodiments of the present invention provide methods, systems, and computer-readable mediums for consolidating and managing hardware maintenance services for hardware devices. In the following detailed description, references are made to accompanying drawings that form a part hereof, and in which are shown by way of illustration specific embodiments or examples. These illustrative embodiments may be combined, other embodiments may be utilized, and structural changes may be made without departing from the spirit and scope of the present invention. The following detailed description is, therefore, not to be taken in a limiting sense, and the scope of the present invention is defined by the appended claims and their equivalents.

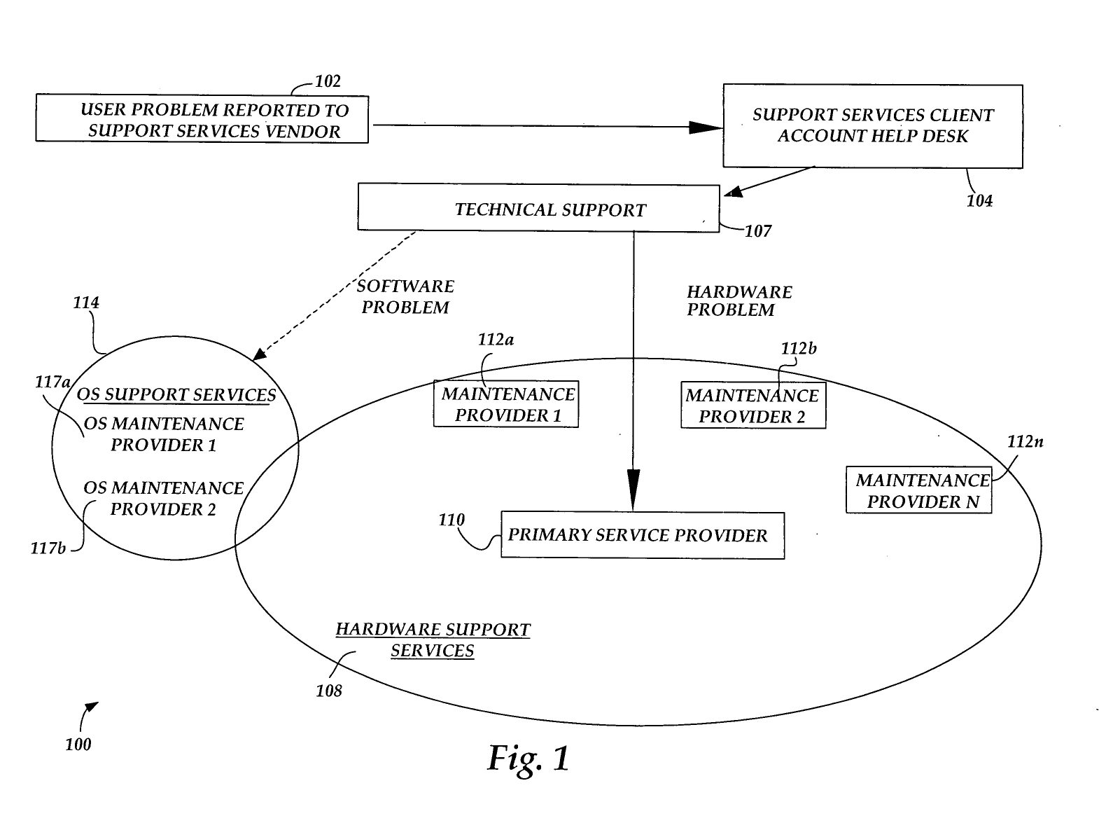

Referring now to the drawings, in which like numerals represent like elements through the several figures, aspects of the present invention and the illustrative operating environment will be described. FIGS. 1-7 and the following discussion are intended to provide a brief, general description of a suitable computing environment in which the embodiments of the invention may be implemented. While the invention will be described in the general context of program modules that execute in conjunction with a BIOS program that executes on a personal or server computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Referring now to FIG. 1, a diagram 100 illustrating the routing of a hardware maintenance problem resolution request according to an illustrative embodiment of the invention will be described. As shown in FIG. 1, a problem resolution request 102 is reported to a support services helpdesk 104. This report may be in the form of a phone call or electronic message to a support services representative. The support services helpdesk 104 forwards the report to technical support 107. Technical support 107 generates problem case data associated with the request 102. Technical support 107 then forwards the problem case data to hardware support 108 when the problem is associated with hardware and to operating system (OS) support 114 when the problem deals with an OS, for example a server's OS.

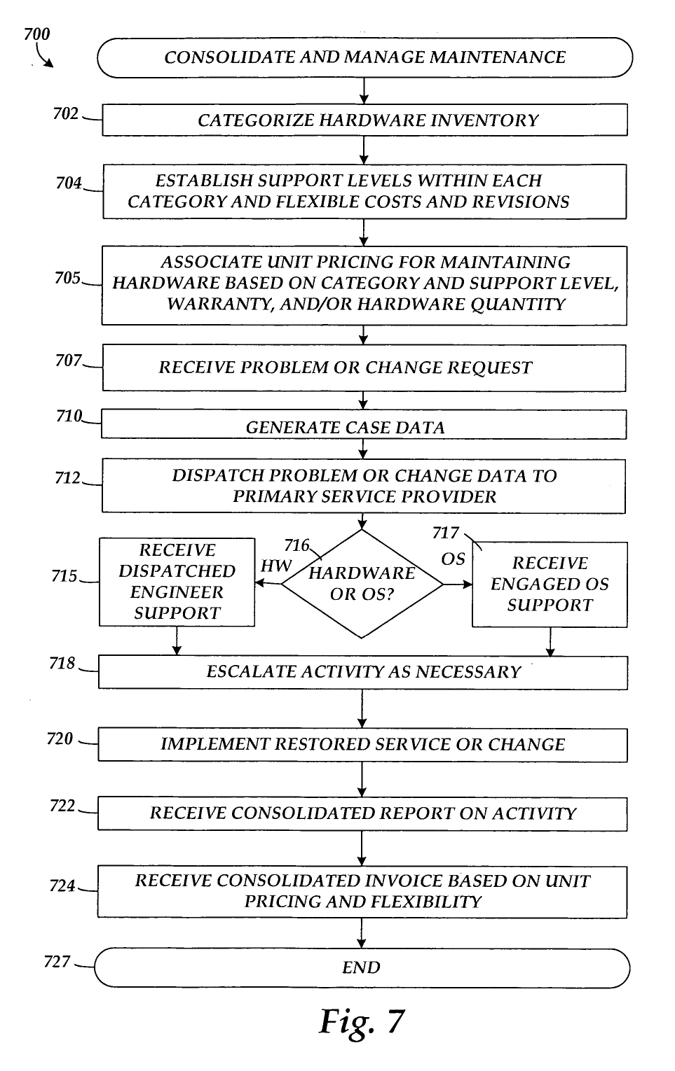

In hardware support 108, the problem case data is forwarded to a primary service provider 110. The primary service provider 110 may handle the problem or subcontract the problem resolution responsibilities to other maintenance providers 112a-112n. The other maintenance providers 112a-112n may include one or more OEMs. However, the sole contact for technical support 107 is the primary service provider 110. Technical support 107 may also contact the primary service provider 110 first even when the problem is OS related. The primary service provider 110 may then subcontract the problem resolution to OS maintenance providers 117a or 117b in OS support 114. However, pricing for the client or customer making the request 102 is still unit pricing. Additional details regarding the flow of a problem resolution request will be described below with respect to FIG. 7.

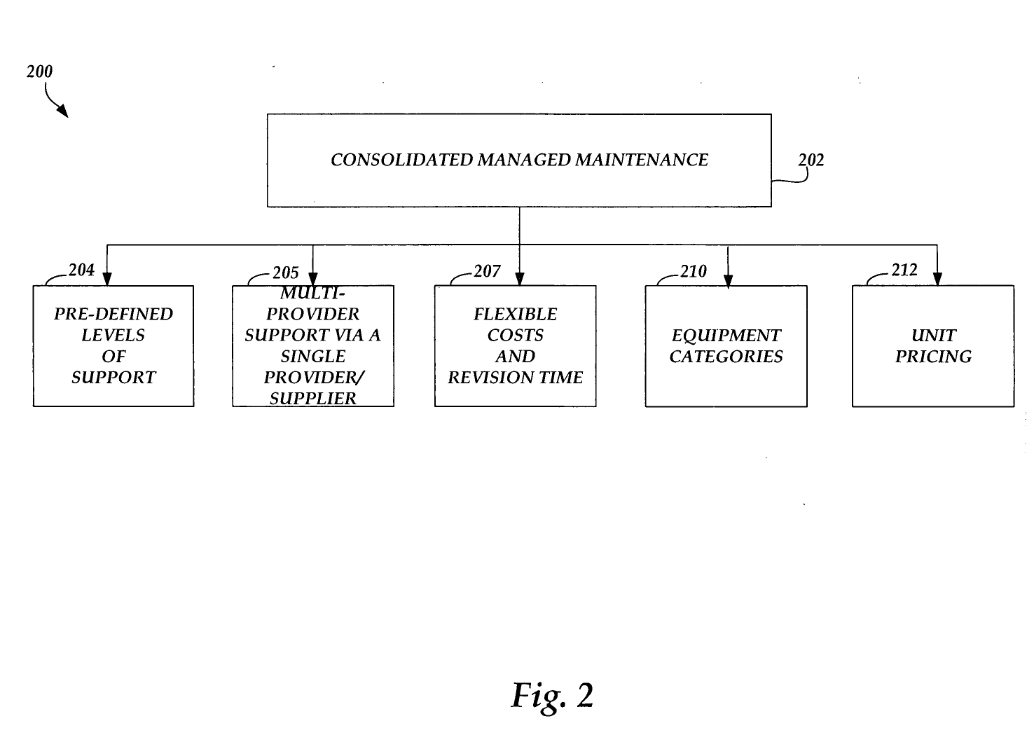

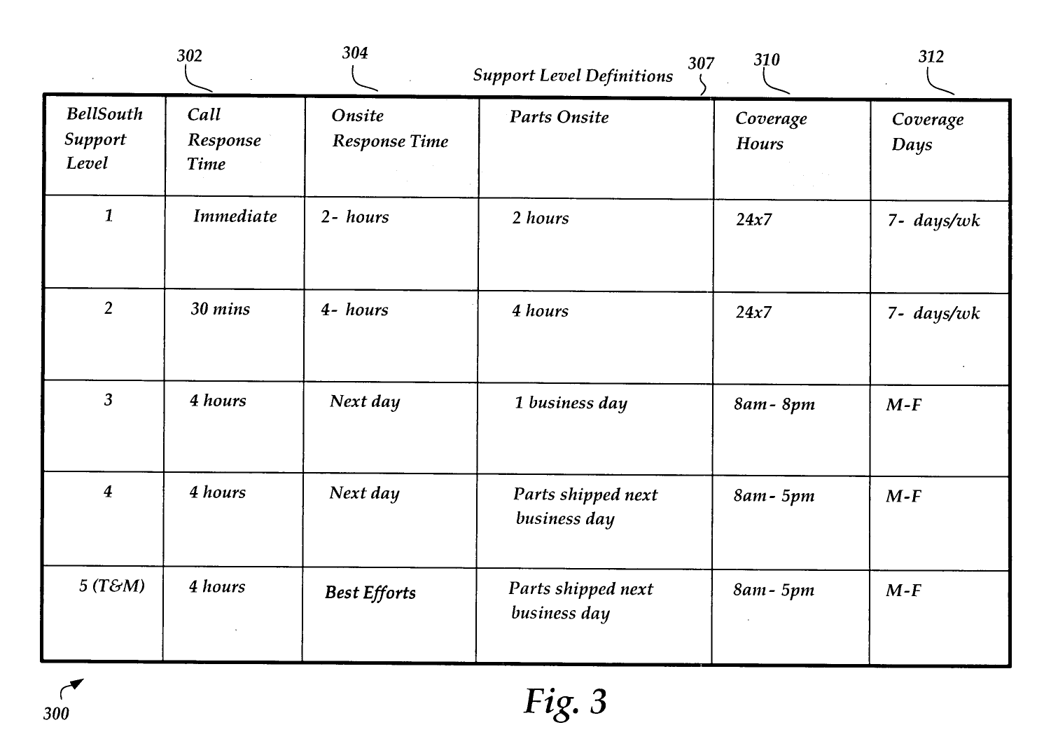

FIG. 2 is a block diagram illustrating various features of a consolidated managed maintenance environment 200 utilized in an illustrative embodiment of the invention. A consolidated managed maintenance program (CMMP) 202 includes a variety of useful features. First of all, the CMMP 202 includes pre-defined levels of support that vary according to break/fix response time and hours of coverage. Referring to FIG. 3, a display 300 of support levels outlining a variety of support response criteria according to an illustrative embodiment of the invention will be described. Support levels 1-5 vary according to phone call response time 302, onsite response time 304, parts onsite response time 307, coverage hours 310, and coverage days 312. For instance, support level 4 and support level 5 differ in that support level 5 has a time and materials (T&M) cost basis and a best efforts onsite response time 304.

Returning now to FIG. 2, the CMMP 202 also includes multiple provider support via a single provider 205. As briefly described above, the primary service provider 110 will serve as the sole contact and invoicing source as far as the client or customer is concerned. However, to meet specialized needs the primary service provider/supplier may subcontract other providers, such as OEMs to provide services when needed. This arrangement thus offers multiple provider support with a single service and billing contact.

Additionally, the CMMP 202 includes flexible costs and revision response time 207. The CMMP 202 provides zero day notice for device additions and removals and no-charge IMACs. The CMMP 202 also provides no charge recertification for hardware devices once covered under the CMMP that are reinstated after being decommissioned or removed from service.

Still further, the CMMP 202 includes equipment categories or groups 210. These categories organize the hardware devices into groups based on number of central processing units (CPUs), model type, size of the hardware devices, shape, processing power, and/or manufacturer. The CMMP 202 also includes unit pricing features 212. The unit pricing features 212 provide fixed pricing for a period of time, such as a contract period. The fixed pricing may vary between equipment categories, manufacturers, levels of support, warranties, no warranties, quantity of hardware devices serviced, and/or year of contract.

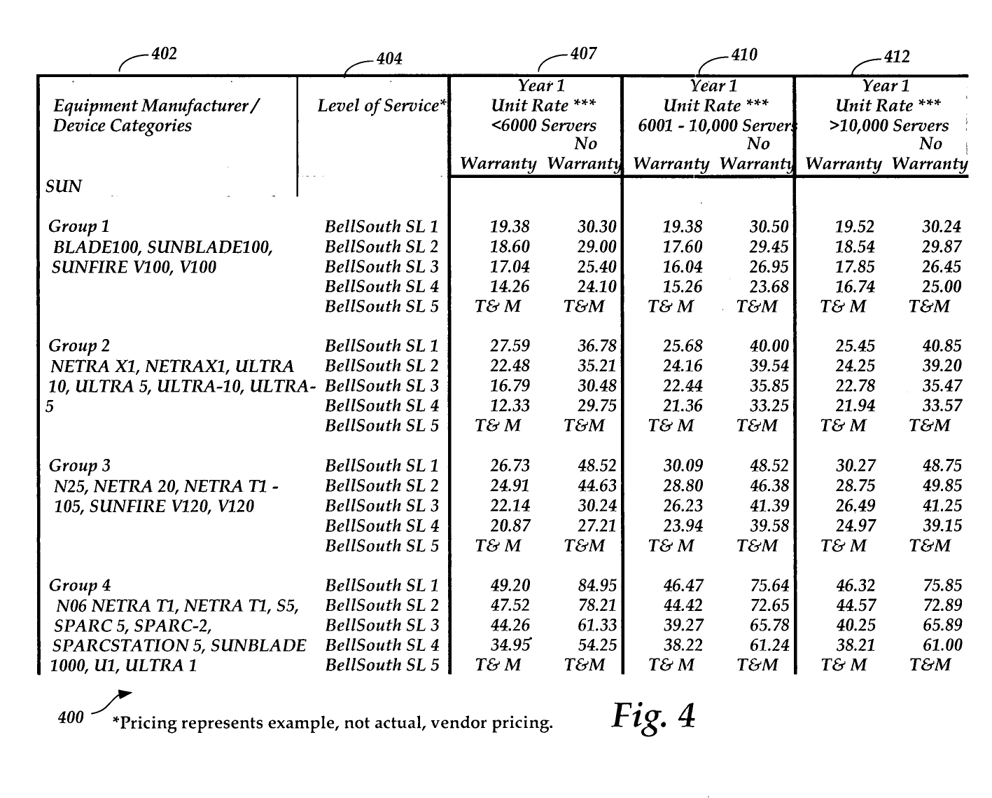

Referring to FIG. 4, a display of example unit pricing 400 based on assigned categories, support level, manufacturer, coverage quantity and/or warranty status according to an illustrative embodiment of the invention will be described. Column 402 outlines equipment manufacturer and/or equipment categories. Column 404 lists the various levels of support as described in FIG. 3. Columns 407, 410, and 412 list pricing options according to warranty status and quantity of hardware devices covered.

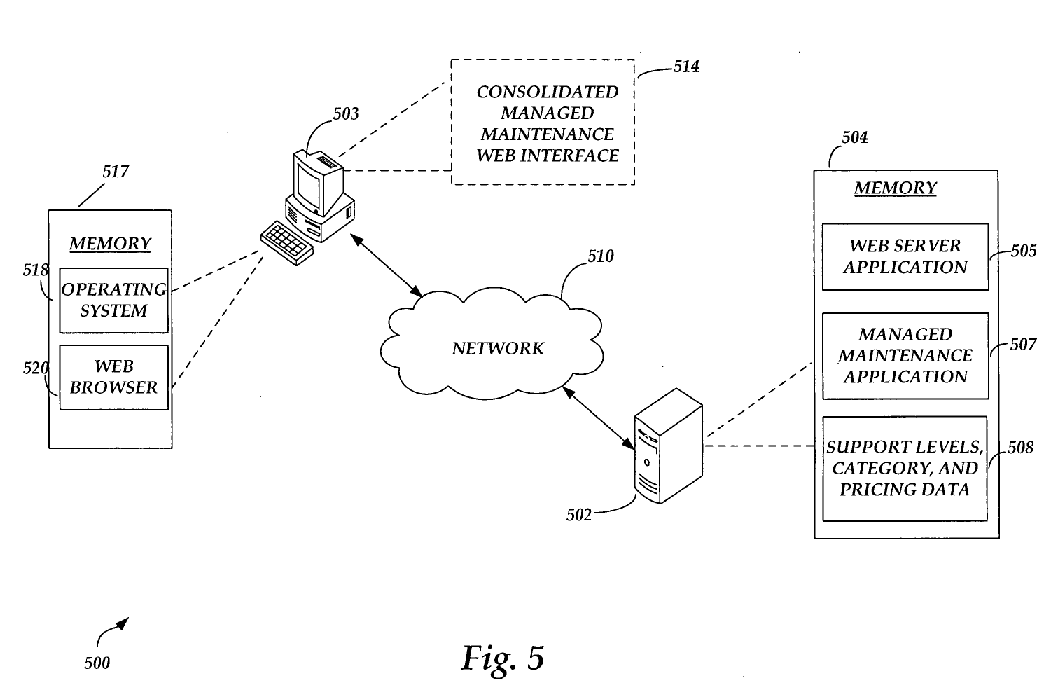

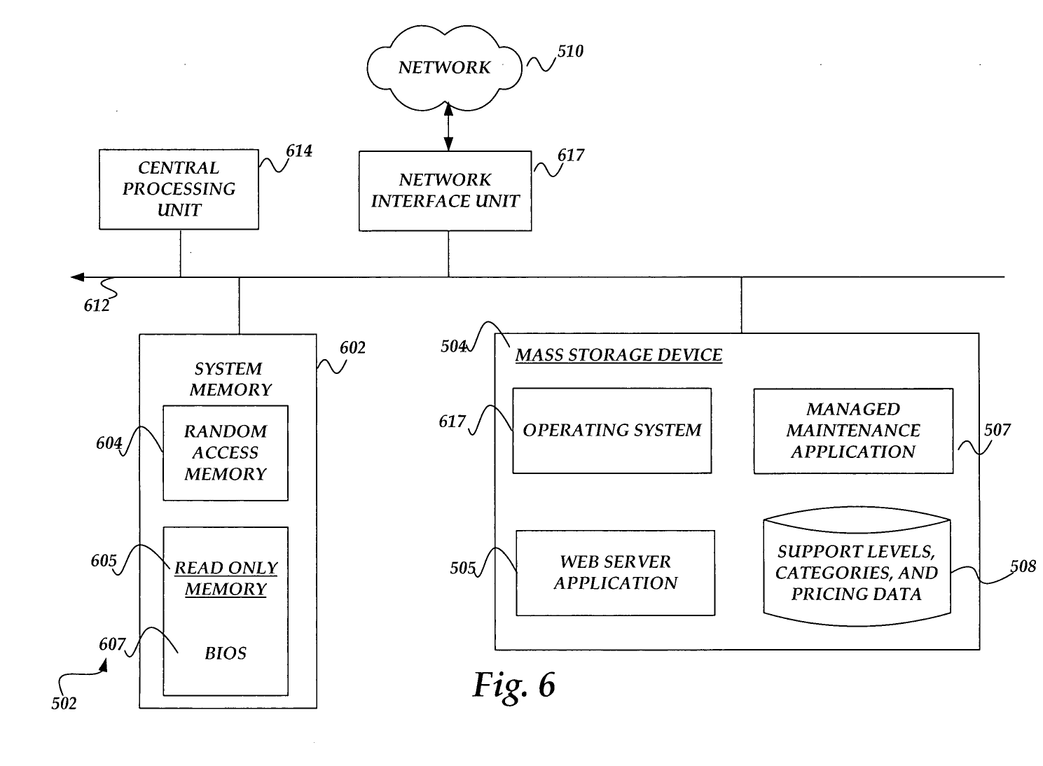

FIG. 5 is a schematic diagram illustrating aspects of a networked operating environment 500 utilized in an illustrative embodiment of the invention. The networked environment 500 includes a web server 502, and a workstation or personal computer (PC) 503 serving as an input and output source for the web server 502 over a network 510 via an interface 514. The web server 502 includes a memory 504 storing a web server application 505, a managed maintenance application (MMA) 507, and a data store 508 that contains support levels, equipment categories, and other pricing data. Additional details regarding the web server 502 will be described below with respect to FIG. 6. The PC 503 includes a memory 517 storing an operating system 518 and a web browser 520. The web browser 520 facilitates the display of the interface 514 generated by the MMA 507 over the network 510.

FIG. 6 illustrates a computing system architecture for the web server 502 utilized in an illustrative embodiment of the invention. The web server 502 includes a central processing unit (CPU) 614, a system memory 602, and a system bus 612 that couples the system memory 602 to the CPU 614. The system memory 602 includes read-only memory (ROM) 605 and random access memory (RAM) 604. A basic input/output system 607 (BIOS), containing the basic routines that help to transfer information between elements within the web server 502, such as during start-up, is stored in ROM 205.

The web server 502 further includes memory such as the mass storage device (MSD) 504 for storing an operating system 617 such as WINDOWS XP, from MICROSOFT CORPORATION of Redmond, Wash., the MMA 507, the web server application 505, and the data store 508 that includes category, support level, and pricing data associated with hardware devices. It should be appreciated that the MSD 504 may be a redundant array of inexpensive discs (RAID) system for storing data. The MSD 504 is connected to the CPU 614 through a mass storage controller (not shown) connected to the system bus 612. The MSD 504 and its associated computer-readable media, provide non-volatile storage for the web server 502. Although the description of computer-readable media contained herein refers to a MSD, such as a hard disk or RAID array, it should be appreciated by those skilled in the art that computer-readable media can be any available media that can be accessed by the CPU 614.

The CPU 614 may employ various operations, discussed in more detail below with reference to FIG. 7 to provide and utilize the signals propagated between the web server 502 and the PC 503 (FIG. 5). The CPU 614 may store data to and access data from the MSD 504. Data is transferred to and received from the MSD 504 through the system bus 612. The CPU 614 may be a general-purpose computer processor. Furthermore, as mentioned below, the CPU 614, in addition to being a general-purpose programmable processor, may be firmware, hard-wired logic, analog circuitry, other special purpose circuitry, or any combination thereof.

According to various embodiments of the invention, the web server 502 operates in a networked environment, as shown in FIG. 5, using logical connections to remote computing devices via network communication, such as an Intranet, or a local area network (LAN). The web server 502 may connect to the network 510 via a network interface unit 617. It should be appreciated that the network interface unit 617 may also be utilized to connect to other types of networks and remote computer systems.

A computing system, such as the web server 502, typically includes at least some form of computer-readable media. Computer readable media can be any available media that can be accessed by the web server 502. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the web server 502.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

FIG. 7 is an illustrative operational flow 700 performed in consolidating and managing hardware maintenance services for a plurality of hardware devices according to illustrative embodiments of the invention. When reading the discussion of the routines presented herein, it should be appreciated that the logical operations of various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated in FIG. 7 and making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims set forth herein.

Referring now to FIGS. 1, 2, and 7, the operational flow 700 performed in consolidating and managing hardware maintenance services for a plurality of hardware devices, according to an illustrative embodiment of the invention, will be described. The operational flow 700 begins at operation 702 where the MMA 507 categorizes each hardware device covered by the CMMP 202.

Next, at operation 704 the MMA 507 establishes support levels within each category and flexible costs and revisions allowing for no cost IMACs and zero day addition/removal notice in the pricing plan. The operational flow 700 then continues to operation 705 where the MMA 507 associates unit pricing with the hardware devices based on the equipment category, manufacturer, support level, warranty status, and/or hardware device quantity.

Next, at operation 707, the MMA 507 receives a problem or change request. This may be in the form of a phone or electronic message. Then at operation 710 the MMA 507 generates case data associated with the request that includes problem or change specifics.

The operational flow 700 then continues to operation 712 where the MMA dispatches problem or change data to the primary service provider 110. Then at operation 716 the MMA 507 determines whether the problem is hardware or OS related. When the problem is OS related, the operational flow 700 continues to operation 717 where OS support is received from a designated provider. The operational flow 700 then continues to operation 718 described below. When the problem is hardware (HW) related, the operational flow 700 continues from operation 716 to operation 715 where support is received from a field engineer.

Next at operation 718, the MMA 507 escalates the problem resolution activity when the support is unable to resolve the problem. Then at operation 720, restored service or the requested change is implemented. The operational flow 700 then continues to operation 722 where a consolidated report is generated and received on all services provided regardless of what hardware devices received service. This report may be received periodically, such as monthly. Then at operation 724, a consolidated invoice is generated and received on all services provided regardless of what hardware devices covered by the CMMP 202 received service. The operational flow 700 returns control to other routines at end operation 727.

Thus, the present invention is presently embodied as methods, systems, computer program products or computer readable mediums encoding computer programs for consolidating and managing hardware maintenance services for a plurality of hardware devices.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for consolidating and managing hardware maintenance services for a plurality of hardware devices, the method comprising:
categorizing each hardware device into one of a plurality of device categories;
establishing support levels each support level defining service response criteria;
pricing services based on at least one of the device category to which a hardware device is assigned or the support level;
receiving a problem resolution request associated with a hardware device and generating problem case data associated with the request; and
dispatching the problem case data to a single primary service provider regardless of which hardware device is associated with the request.

2. The method of claim 1, further comprising:
receiving hardware maintenance services associated with the request;
receiving a single consolidated report describing all the hardware maintenance services rendered during a period for all hardware devices receiving hardware maintenance services; and
receiving a single invoice including costs for all the hardware maintenance services rendered during a period regardless of which hardware devices received hardware maintenance services.

3. The method of claim 2, wherein receiving hardware maintenance services comprises at least one of the following:
receiving technical services from a dispatched field engineer in response to determining that the problem case data is associated with a hardware problem; and
receiving technical services from engaged operating system support in response to determining that the problem case data is associated with an operating system problem.

4. The method of claim 1, further comprising:
receiving a change request associated with a hardware device wherein the change request comprises a request to at least one of install, move, add, or change a hardware device.

5. The method of claim 4, wherein the change request is implemented with zero day notice.

6. The method of claim 4, wherein the change request is implemented with no charge.

7. The method of claim 4, wherein the change request comprises a request to install a hardware device further comprising recertifying the hardware device without a charge.

8. The method of claim 4, wherein the change request comprises a request to change a support level assigned to a hardware device wherein the support level is changed with zero day notice.

9. The method of claim 1, wherein the change request is implemented as an addition or removal of a hardware device to or from a consolidated managed maintenance program (CMMP) and wherein the addition or removal is reflected in a monthly invoice as a prorated charge or credit.

10. The method of claim 1, wherein categorizing each hardware device comprises categorizing each hardware device based on at least one of a size, a model, a shape, or a processing power of each hardware device.

11. The method of claim 1, wherein establishing support levels comprises defining service response criteria per support level for at least one of the following:
request response time;
onsite response time;
time for parts to arrive onsite;
service coverage hours; and
service coverage days.

12. The method of claim 1, wherein pricing services comprises fixing service prices for one or more periods of time with or without an original equipment manufacturer warranty thereby making prices predictable, flexible, and competitive.

13. A computer program product comprising a computer-readable medium having control logic stored therein for causing a computer to consolidate and manage hardware maintenance services for a plurality of hardware devices, the control logic comprising computer-readable program code for causing the computer to:
categorize each hardware device into one of a plurality of device categories;
establish support levels each support level defining service response criteria;
price services based on at least one of the device category to which a hardware device is assigned or the support level;
receive a problem resolution request associated with a hardware device and generate problem case data associated with the request; and
dispatch the problem case data to a single primary service provider regardless of which hardware device is associated with the request.

14. The computer program product of claim 13, further comprising computer-readable program code for causing the computer to:
generate a single consolidated report describing all the hardware maintenance services rendered during a period for all hardware devices receiving hardware maintenance services; and
generate a single invoice including costs for all the hardware maintenance services rendered during a period of time for all hardware devices receiving hardware maintenance services during the period of time.

15. The computer program product of claim 13, further comprising, computer-readable program code for causing the computer to:
receive a change request associated with a hardware device wherein the change request comprises a request to at least one of install, move, add, or change a hardware device.

16. The computer program product of claim 15, further comprising, computer-readable program code for causing the computer to record implementation of the change request in association with no charge.

17. A computer-implemented system for consolidating and managing hardware maintenance services for a plurality of hardware devices, the system comprising:
means for categorizing each hardware device into one of a plurality of device categories;
means for establishing support levels each support level defining service response criteria;
means for pricing services based on at least one of the device category to which a hardware device is assigned or the support level;
means for receiving a problem resolution request associated with a hardware device; and
means for dispatching the problem resolution request to a single primary service provider for any hardware device associated with the request.

18. The system of claim 17, further comprising:
means for generating a single consolidated report describing all the hardware maintenance services rendered during a period of time for any hardware devices receiving hardware maintenance services; and
means for generating a single invoice including costs for all the hardware maintenance services rendered during the period of time for any hardware devices receiving hardware maintenance services.

19. The system of claim 18, further comprising:
means for receiving a change request associated with a hardware device wherein the change request comprises a request to at least one of install, move, add, or change a hardware device.

20. The system of claim 19, wherein the change request is implemented with at least one of zero day notice, next day service, or without a charge.
